(19) United States
(12) Patent Application Publication
(10) Pub. No.: US 2025/0227006 A1
(43) Pub. Date: Jul. 10, 2025

(54) DOCSIS Channel Profile Generation

(71) Applicant: Harmonic, Inc., San Jose, CA (US)

(72) Inventors: Lior Assouline, Rishon Lezion (IL); Ariel Zaltsman, Raanana (IL)

(73) Assignee: Harmonic, Inc., San Jose, CA (US)

(21) Appl. No.: 19/015,172

(22) Filed: Jan. 9, 2025

Related U.S. Application Data
(60) Provisional application No. 63/619,684, filed on Jan. 10, 2024.
(60) Provisional application No. 63/566,853, filed on Mar. 18, 2024.
(60) Provisional application No. 63/564,980, filed on Mar. 13, 2024.

(51) Int. Cl. H04L 12/28

(52) U.S. Cl. CPC H04L 12/2801

(57) ABSTRACT

Dynamic creation of a Data Over Cable Service Interface Specification (DOCSIS) modulation profile. Conditions of a channel are probed to obtain a plurality probing samples, which are data that describe observed conditions of the channel. The plurality of probing samples is clustered to identify one or more clusters, which are each represented by one or more cluster center points. For each cluster, a spread value is determined. The spread value is data that describes a shape and size of the cluster relative to the one or more cluster center points associated therewith. For each cluster, a threshold modulation error (MER) is identified using the one or more cluster center points associated therewith and the spread value determined for that cluster. The threshold MER identified for each cluster is converted into a bit loading value. A modulation profile is created for each cluster using the bit loading value for that cluster.

### CLAIM OF PRIORITY

The present application claims priority to U.S. Provisional Patent Application No. 63/619,684, filed on Jan. 10, 2024, entitled ‘DOCSIS Channel Profile Generation,’ the entire contents of which are incorporated by reference for all purposes as if fully set forth herein.

### FIELD OF THE INVENTION

Embodiments of the invention generally relate to the dynamic creation of a Data Over Cable Service Interface Specification (DOCSIS) modulation profile for an orthogonal frequency-division multiplexing (OFDM) and/or an orthogonal frequency-division multiple access (OFDMA) channel.

### BACKGROUND

Data Over Cable Service Interface Specification (DOCSIS) is a widely used industry standard for transferring digital data over the existing cable television (CATV) infrastructure. DOCSIS version 3.1 introduced the concept of a profile for an orthogonal frequency-division multiplexing (OFDM) channel.

OFDM is a multiplexing technique used to simultaneously send multiple signals, or channels, over a single transmission medium such that the signals constituting the separate channels overlap. The overlapping signals do not interfere with one another because the signals are orthogonal, i.e., when each individual signal is at its peak, the adjacent signals are at their null point. OFDM provides for greater throughput of data due to the allowance of overlapping of signals in contrast to prior multiplexing approaches such as frequency-division multiplexing.

The profile for an OFDM channel may be used by a CATV operator to describe the information that a cable modem needs to possess to communicate over that OFDM channel. A Cable Modem Termination System (CMTS) may define one or more profiles for a particular OFDM channel. Each profile for a particular OFDM channel describes a different set of parameters, such as modulation order (commonly referred to as a ‘constellation’ or bit-loading value), Forward Error Correction (FEC), preamble, and guard interval, which defines how data is to be exchanged between a cable modem and the CMTS for that OFDM channel. As mentioned, a typical DOCSIS modulation profile identifies a bit-loading value for each channel that identifies how many bits to transmit over the channel per time unit.

The DOCSIS 3.1 specification informs that up to 16 profiles may be defined for a particular OFDM channel. Version 3.1 of the specification further provides a way to assign a group of profiles to a cable modem and recommends ways how to choose the best profile to use for exchanging data with each cable modem over a particular OFDM channel.

By convention, each profile is assigned a letter, e.g., profile A, profile B, and so on. Profile A is a common profile that is assigned to each cable modem for a particular OFDM channel, while the other profiles assigned for that particular OFDM channel may differ from cable modem to cable modem.

Each OFDM channel has its own unique set of profiles. For example, profile A on OFDM channel 1 will be different than profile A on OFDM channel 2.

The parameters that describe a OFDM channel are defined in a OFDM Channel Descriptor (OCD) message, and each profile for an OFDM channel are defined in a Downstream Profile Descriptor (DPD) message. The OCD and DPD messages are sent to all cable modems in the CATV system on a PHY Link Channel (PLC). When a cable modem initializes, it will use profile A for a particular OFDM channel until instructed by the CMTS to use a different profile.

The DOCSIS 3.1 specification describes how the CMTS may obtain, from a particular cable modem, information about the Signal to Noise ratio (SNR) for a particular OFDM channel. The specification also provides for the CMTS to request a particular CM to assess a particular profile and report to the CMTS information about its SNR and FEC. The CM-SP-PHY DOCSIS 3.1 specification includes an algorithm which may be used by a CMTS to select a profile for use in conjunction with a particular OFDM channel by a particular cable modem based the information and statistics about the SNR, FEC, and related parameters obtained from that cable modem.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram of a Converged Cable Access Platform (CCAP) platform in which an embodiment of the invention may be deployed;

FIG. 2 is a flowchart illustrating the steps of dynamic creation of a Data Over Cable Service Interface Specification (DOCSIS) modulation profile for an orthogonal frequency-division multiplexing (OFDM) channel according to an embodiment of the invention.

FIG. 3 is a diagram that illustrates an exemplary plot of probing results from many cable modems around a particular modulation error (MER) in accordance with an embodiment of the invention;

FIG. 4 is an illustration depicting probing results from many cable modems around a particular modulation error (MER) in accordance with an embodiment of the invention;

FIG. 5 is an illustration of the result of clustering probing samples into a set of clusters in accordance with an embodiment of the invention;

FIG. 6 is an illustration of determining how much variance there is between probing samples represented by each cluster in accordance with an embodiment of the invention; and

FIG. 7 is an illustration of a heatmap of different sets of optimized modulation profiles in accordance with an embodiment of the invention.

### DETAILED DESCRIPTION

Embodiments are directed towards dynamically creating a DOCSIS modulation profile for an orthogonal frequency-division multiplexing (OFDM) channel. The modulation profiles created using the techniques discussed herein may also be used with orthogonal frequency-division multiple access (OFDMA) channels. In the following description, for the purposes of providing a detailed explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form or discussed at a high level in order to avoid unnecessarily obscuring teachings of embodiments of the invention.

While DOCSIS modulation profiles existed in the prior art, embodiments of the invention are directed towards an innovative new and novel approach for their creation that yields a variety of enhancements and advantages over the current state of the art. The dynamically created profiles of an embodiment are not assigned to cable modems based on the physical deployment location of the cable modems or any characteristics of service provider customers associated with the cable modems, but rather based on the periodical channel conditions, includes ingress noise and other interference patterns, which may be experienced by those cable modems to which the profile is assigned.

Embodiments of the invention enable the dynamic creation of optimized DOCSIS modulation profiles which may be used in the upstream (US) direction as well as in the downstream (DS) direction. While concrete examples may be discussed herein relative to the upstream (US) direction or the downstream (DS) direction, those in the art shall appreciate that the concrete examples herein do not limit the creation or use of modulation profiles of an embodiment to either the US or the DS. When discussing certain portions of the spectrum, different terms may be used to identify certain levels of granularity, but those in the art shall appreciate that shall terms may have a corollary in the other direction. As an example, DOCSIS DS OFDM bit-loading over the channel frequencies is at provided at the subcarrier resolution. The subcarrier resolution is either 25 Khz or 50 Khz depending on the DOCSIS OFDM subcarrier spacing type used. On the other hand, DOCSIS Upstream OFDMA bit-loading over the channel frequencies is at provided at the minislot resolution at 400 kHz.

As another example, a DOCSIS DS OFDM channel may consist up to 7600 subcarriers. On the other hand, a DOCSIS US OFDMA channel may consist up to 237 minislots. Each OFDMA minislot consists of 8 or 16 subcarriers of 50 khz or 25 khz respectively.

Before discussing certain embodiments of the invention, it will be helpful to review the operational context in which certain embodiments may be employed. For this reason, a brief discussion of upstream and downstream communications in a Converged Cable Access Platform (CCAP) will now be presented.

### Upstream and Downstream Communications in a CCAP Platform

Embodiments of the invention are directed towards the dynamic creation of a Data Over Cable Service Interface Specification (DOCSIS) modulation profile for an OFDM and/or OFDMA upstream or downstream, channel. As is well-known to those in the field of cable networks, DOCSIS is a widely used industry standard for transferring digital data over the existing cable television (CATV) infrastructure, and is widely used in Converged Cable Access Platform (CCAP) deployments. CCAP is an industry standard platform for transmitting video data and voice content.

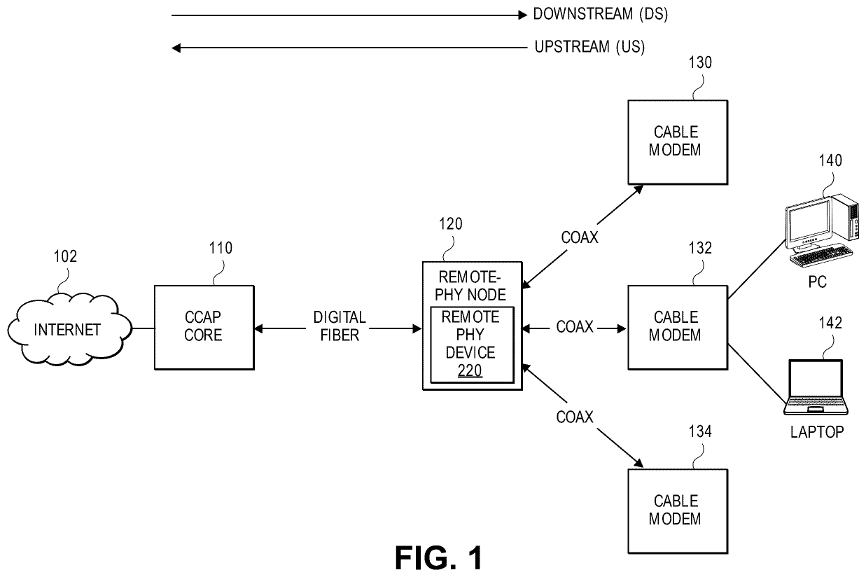

FIG. 1 is a block diagram of a CCAP platform in which an embodiment of the invention may be deployed. The CCAP platform shown in FIG. 1 includes CCAP Core 110, Remote PHY node 120, a plurality of cable modems 130, 132, 134, and cable subscriber network devices 140, 142. The CCAP platform shown in FIG. 1 may be implemented by a virtual CCAP platform that executes on hardware components that include a commercial off-the-shelf switch/router and one or more off-the-shelf computing servers. A commercial example of a virtual CCAP is CableOS™, available from Harmonic, Inc. of San Jose, California.

FIG. 1 depicts a downstream (DS) direction (i.e., CCAP Core 110 to cable subscribers' network devices) and an upstream (US) direction (i.e., cable subscribers' network devices to CCAP Core 110). According to embodiments of the invention, DOCSIS modulation profiles may be created by, or at a location accessible to, CCAP Core 110. CCAP Core 110 may send OFDM Channel Descriptor (OCD) messages and Downstream Profile Descriptor (DPD) messages to cable modems 130, 132, 134 to inform those cable modems of the created DOCSIS modulation profiles. Cable modems 130, 132, 134 may thereafter use the created DOCSIS modulation profiles in sending communications to CCAP Core 110.

CCAP Core 110, as broadly used herein, refers to a CCAP Core as described in the Remote PHY family of specifications, known as the MHAv2 specifications and administrated by CableLabs® of Louisville, Colorado. CCAP Core 110 may communicate over Internet 102 (as shown in FIG. 1) or one or more private networks (not depicted in FIG. 1).

CCAP Core 110 may correspond to an integrated CCAP that performs the functions of a Cable Modem Termination System (CMTS) and an edge QAM (EQAM). Alternately, CCAP Core 110 may communicate with one or more other devices which perform functions pertaining to a CMTS and/or an EQAM.

CCAP Core 110 is typically located at a headend and is used to provide high speed data services to network devices. For example, FIG. 1 depicts two network devices 140, 142, each of which exchanges data with cable modem 132, which in turn exchanges data with CCAP Core 110 by way of Remote PHY node 120. As will be readily appreciated, a practical implementation of a CCAP platform will include many different Remote PHY nodes 120, many different cable modems, and many different network devices; however, for simplicity and ease of explanation, the large numbers of those entities are not depicted in FIG. 1.

Remote PHY node 120, with the assistance of a Remote PHY device 220 converts downstream DOCSIS data, MPEG video, and out-of-band (OOB) signals from digital to analog and upstream data, video, and OOB signals from analog to digital. A non-limiting, illustrative example of Remote PHY node 120 is the CableOS™ Ripple-1 Remote PHY node, available from Harmonic, Inc. of San Jose, California. While only a single Remote PHY node 120 is depicted in FIG. 1, practical implementations will a large plurality of Remote PHY nodes in communication with CCAP Core 110.

Remote PHY node 120 is designed to be deployed outdoors near the physical locations of cable modems 130, 132, 134. Remote PHY node 120 is composed of an outer housing that is designed to provide a hermetically sealed environment to the interior of Remote PHY node 120 to protect internal components from outdoor environmental factors, such as humidity, water, debris, and changes in pressure. While only three DOCSIS cable modems are depicted in FIG. 1, practical implementations will have varying numbers of cable modems serviced by a particular Remote PHY node 120. For example, it is not uncommon for more than 100 cable modems to be serviced by a single Remote PHY node 120.

One such internal component enclosed by Remote PHY node 120 is a Remote PHY device 220. Remote PHY node 120 may comprise one or more Remote RHY devices 220. Remote RHY device 220 is a computerized device which performs many of the functions involved in converting downstream DOCSIS data, MPEG video, and out-of-band (OOB) signals from digital to analog and upstream data, video, and OOB signals from analog to digital. A non-limiting, illustrative example of Remote RHY device 220 is Harmonic, Inc.'s CableOS™ Pebble-1 Remote PHY device.

### Identify Ingress Noise Patterns

Cable modems, such as cable modems 130, 132, 134 of FIG. 1, occasionally experience ingress noise or other temporary impairments to certain parts of the upstream spectrum of a CCAP platform. Such noise and/or impairments reduce the quality and capacity of the upstream channel, which may result in a perceptible negative user experience due to retransmissions and increased network latency. The occasional noise and/or impairments may be of such magnitude as to cause a particular cable modem to enter partial mode, which refers to a mode of the cable modem in which the cable modem no longer possesses the ability to transmit in one or more channels, but otherwise is able to continue to operate. For example, if a particular cable modem experiences a prolonged impairment to a particular upstream channel, that cable modem may enter partial mode and become unable to use that upstream channel experiencing the impairment.

Approaches are presented herein for automating and optimizing DOCSIS modulation profile creation. DOCSIS modulation profiles are used when transmitting over a DOCSIS channel. Advantageously, embodiments of the invention enable increased quality and capacity in the upstream spectrum of a CCAP by allowing profiles to be dynamically created and deployed based on actual and recently observed conditions of the spectrum. As a result, embodiments of the invention result in fewer cable modems being required to operate in partial mode, because the profiles employed by the cable modems were created with an understanding and insight into the present operational conditions of the upstream spectrum. Embodiments of the invention beneficially allow for an optimized DOCSIS modulation profile to be created and deployed for a channel such that the actual signal-to-noise (SNR) ratio of that channel satisfies the minimum requirements of that DOCSIS profiles

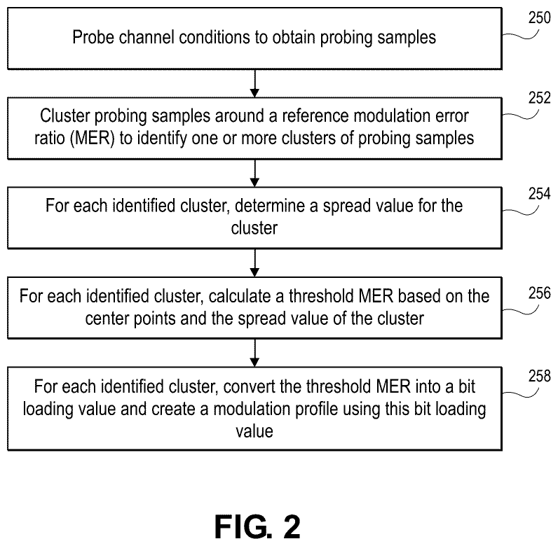

FIG. 2 is a flowchart illustrating the steps of dynamic creation of a Data Over Cable Service Interface Specification (DOCSIS) modulation profile according to an embodiment of the invention. The modulation profile may be an orthogonal frequency-division multiplexing (OFDM) modulation profile or an orthogonal frequency-division multiple access (OFDMA) modulation profile, for example. The steps of FIG. 2 will be explained with reference to a simplified example of an embodiment involving a two minislot OFDMA DOCSIS channel. As well known in the art, a minislot of a OFDMA channel is a short, repeating, scheduled amount of time-frequency allocated to a particular cable modem during which that particular cable modem may be granted to transmit in the upstream direction over that particular channel.

While the steps of FIG. 2 will be explained below largely in relation to a concrete example involving a modulation profile used in an upstream direction, it should be understood to those in the art that the steps of FIG. 2 may be used to create a modulation profile for use in the downstream direction as well.

Initially, in step 250, in order to create a set of profiles for a single channel (referred to below as the “channel being profiled”), CCAP Core 110 probes conditions of the channel being profiled to obtain probing samples. As used herein, the term “probing samples” refers to data, collected by CCAP Core 110, that describes conditions of the channel being profiled. Probing samples may correspond to receiver MER vectors or SNR vectors. CCAP Core 110 may obtain probing samples for the channel being profiled in the upstream direction by probing upstream (US) transmissions via one modulation error rate (MER), which shall be referred to below by the name ‘the reference MER.’ CCAP Core 110 may obtain probing samples for the channel being profiled in the downstream direction in several ways, such as by probing downstream (DS) transmissions sent by CCAP Core 110 using Simple Network Management Protocol (SNMP) requests to cable modems over the channel being profiled. Another approach CCAP Core 110 may take to obtain probing samples for the channel being profiled in the downstream direction is to use OPT-REQ messages to instruct cable modems to report information about their RxMER (MER per subcarrier) to CCAP Core 110 in an OPT-RSP message. Other approaches for measuring the quality of a channel may be used without deviating from the spirit and scope of the embodiments of the invention described herein.

The DOCSIS 3.1 specification requires that a certain minimum average Modulation Error Ratio (MER), expressed in dB, be supported at the receiver (abbreviated as ‘RxMER’) for each channel. The MER is the ratio, in decibels, of the average symbol power to average error power. MER provides a measure of the “fuzziness” or spreading of a constellation's clouds of plotted symbol points. The DOCSIS 3.1 specification also requires that a certain Modulation bitload (bit per symbol)/Modulation order be supported by the receiver of each channel.

To illustrate, the required average RxMER as the MER thresholds per modulation order by the DOCSIS 3.1 specification is as follows: (a) for a constellation (modulation order) of 4096, the carrier to noise ratio (dB), or MER threshold, is 41.0, (b) for a constellation (modulation order) of 2048, the carrier to noise ratio (dB), or MER threshold, is 37.0, (c) for a constellation (modulation order) of 1024, the carrier to noise ratio (dB), or MER threshold, is 34.0, (d) for a constellation (modulation order) of 512, the carrier to noise ratio (dB), or MER threshold, is 30.5, (e) for a constellation (modulation order) of 256, the carrier to noise ratio (dB), or MER threshold, is 27.0, (f) for a constellation (modulation order) of 128, the carrier to noise ratio (dB), or MER threshold, is 24.0, (g) for a constellation (modulation order) of 64, the carrier to noise ratio (dB), or MER threshold, is 21.0, and (h) for a constellation (modulation order) of 16, the carrier to noise ratio (dB), or MER threshold, is 15.0. Thus, the DOCSIS 3.1 specification requires that a channel transmission sent with a modulation order of 512 to have a MER of 30.5 dB.

In an embodiment of the invention, the probing samples collected in step 250 may be filtered for invalid or bad samples or data. It should be appreciated that the particular times or intervals at or over which probing samples are collected are less important than representing the variety of channel conditions as accurately as possible.

### Identify Clusters Within the Probing Samples

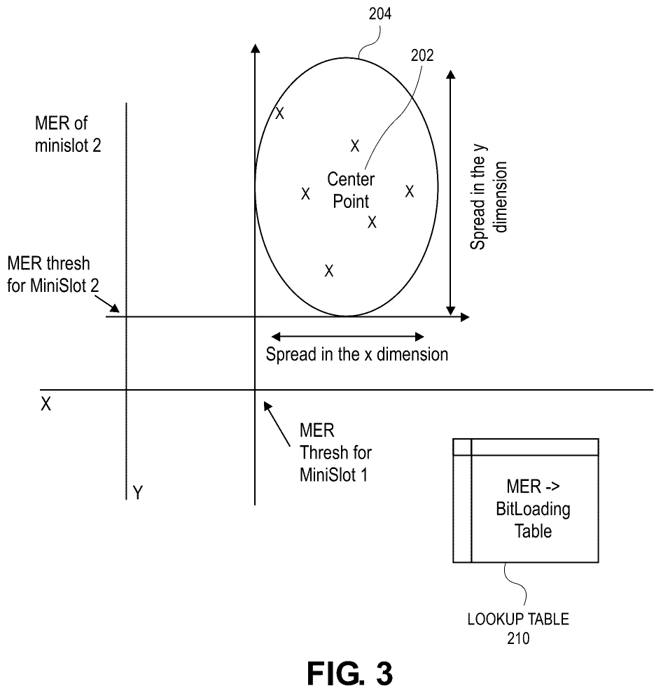

After probing channel conditions to obtain probing samples for the channel being profiled, in step 252, CCAP core 110 clusters the probing samples obtained in step 250 around the reference MER of step 250 for purposes of identifying one or more clusters of probing samples. Step 252 will be explained with reference to FIG. 3, which is a diagram that illustrates an exemplary plot of probing samples from many cable modems around a reference MER in accordance with an embodiment of the invention. In the example of FIG. 3, the probing samples from many cable modems are represented by X's, and the units of both the X-axis and the Y-axis are dB. FIG. 3 depicts a threshold for two different minislots, referred to as minislot 1 and minislot 2. Real OFDMA samples have 100's of minislots, resulting in high dimensional points. In order to be able to graphically depict the clustering process of step 252, a simplified example is shown in FIG. 3 that involves only two minislots, and thus two dimensions, so that the clustering may be represented in a two-dimensional format that facilitates cluster visualization.

In an embodiment, a K-means clustering algorithm, which is widely known to those in the art, may be used in step 252 to identify one or more cluster center points, which may be used as a proxy or representation of each cluster. For example, in performing the simplified example of shown in FIG. 3, center point 202 of cluster 204 may be determined in step 252 using a K-means clustering algorithm. A K-means clustering algorithm may receive as input N points in a certain dimension (e.g., such as the probing samples of cluster 204) and return as output K points, which correspond to the center points of those N points such that the accumulated (Euclidean) distance of the points to their assigned centers is approximately minimal. The purpose of determining the K center points using the K-means clustering algorithm in step 252 is to obtain an accurate representation of the N probing samples. In effect, the goal is to summarize the N probing samples, which may reflect noise and/or interference, using a smaller number of K center points, which represent most (or at least a representative sample) of the N probing samples. It should be noted that the use of similar or variant of a clustering algorithms such as, but not limited to, DBSCAN, GMM with other distances metrics such as, but not limited to, Manhattan, Minkovsky or an SNR quantized dependent distance, may be employed by embodiments of the invention without deviating from the spirit or scope of the invention.

In this example, assume that the channel over which the probing samples were obtained is stable, and as such, the probing samples are relatively closely centered around center point 202 in a single cluster 204. Note that if the probing results were not relatively closely centered around center point 202, then multiple clusters might be depicted in FIG. 3. As shall be explained below, embodiments of the invention will dynamically create a profile for each cluster of profile samples identified in step 252.

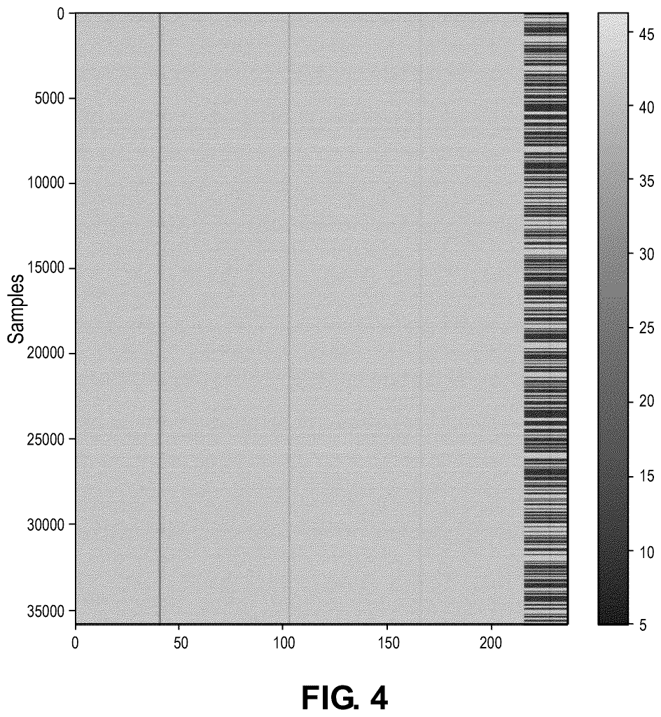

FIG. 4 is an illustration depicting probing results from many cable modems in accordance with an embodiment of the invention. FIG. 4 depicts over 35,000 probing samples gathered over the course of a day. The probing samples may be obtained at regular intervals from all cable modems on a specific upstream (or downstream) port. Also, probing samples may be obtained from all cable modems on a specific virtualized port corresponding to a few physical channels that share a common profile scheduler.

In the example shown in FIG. 4, each probing sample describes an upstream channel having 273 minislots; consequently, in the example of FIG. 4, each probing sample is a vector of 273 numbers that correspond to MER measurements of a specific minislot. A lower value in a probing sample vector means that the area of the spectrum associated with that value (such as a minislot in case of the upstream direction) was measured having a higher average error rate, and consequently that minislot can only support a lower modulation or less data, i.e., fewer bits per minislot. On the other hand, a higher value in the probing sample vector means that the area of the spectrum associated with that value was measured as relatively clean, and consequently that area of the spectrum can support a higher modulation (i.e., more data or more bits per minislot). In FIG. 4, the scale is expressed in dB, and the grayscale colors become whiter as the vector values become higher. Embodiments of the invention may be employed with probing samples having any number of minislots; e.g., probing samples may be represented as a vector of M values of MERs in dB representing K clusters of channel conditions.

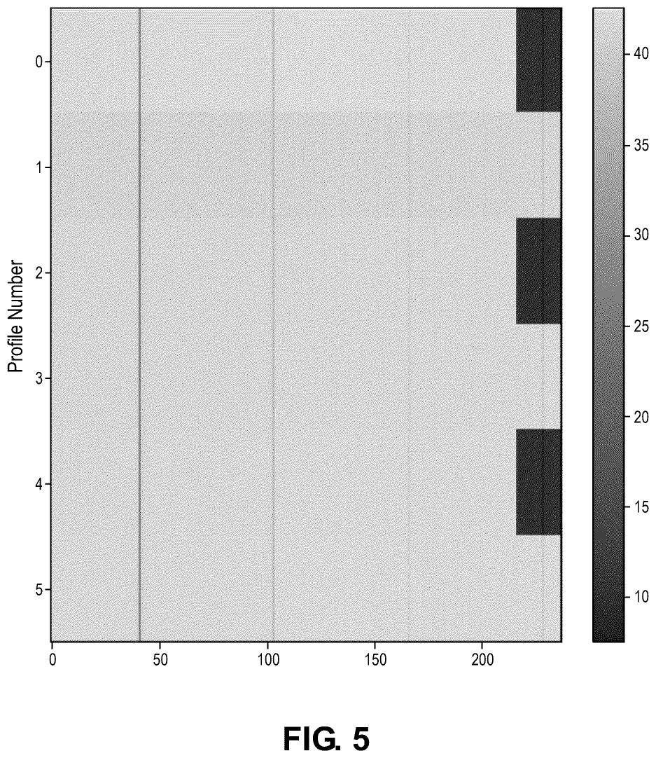

FIG. 5 is an illustration of the result of clustering probing samples into a set of clusters in accordance with an embodiment of the invention. For example, the over 35,000 probing samples depicted in FIG. 4 may be clustered into the six clusters depicted in FIG. 5 using a K-means clustering algorithm. As shown in FIG. 5, the six clusters are numbered 0-5 as identified by the Y-axis, while the minislot numbers are identified by X-axis. The color of the greyscale depicted for each area of the spectrum for each cluster represents the associated MER measurement, as shown in the vertical scale, expressed in dB, on the right of FIG. 5.

As a result of performing step 252, for each identified cluster, a set of one or more center points are identified to represent each individual cluster.

### Ascertain how Noise Affects Each Cluster of Probing Samples

Having calculated one or more cluster center points for each cluster, in step 254, CCAP core 110 determines a spread value for each cluster identified in step 252. The spread value of a cluster is data that describes the shape and size of the cluster, which in turn reflects how noise and/or interference in the spectrum has influenced the probing samples. The more variations in the noise and/or interference present in the spectrum when probing samples are collected, the more spread out the probing samples will be in a cluster; conversely, the less variations in the noise and/or interference present in the spectrum when probing samples are collected, the less spread out the probing samples will be in a cluster. Note that FIG. 3 is a simplified example, and embodiments of the invention may operate on any number of probing samples.

Consideration must be made as to the shape and/or the spread of each cluster. To do so in the simplified example shown in FIG. 3, the spread of cluster 204 in both the X and Y dimension is determined by identifying the exterminates of the perimeter of each cluster in those directions. In the example of FIG. 3, there is only one cluster, namely cluster 204; consequently, the CMTS need only perform step 254 once to obtain one spread value for cluster 204 in the example shown in FIG. 3. However, if there were multiple clusters shown in FIG. 3, then in the performance of step 254, a separate spread value would be created in step 254 for each cluster.

CCAP core 110 cannot create a profile for the cluster 204, associated with center point 202, solely based on the MER associated with center point 202 because roughly half of the probing sample results grouped in the cluster represented by center point 202 are associated with a MER value less than that of center point 202, and so they could not be sent with the calculated profile. The MER associated with center point 202 represents average channel conditions for which approximately half the probing samples were plotted on either side of that center point in step 252; therefore, any modulation profile requiring the channel conditions associated with the center point 202 of cluster 204 would be too strict for too many of the probing samples of cluster 204 to be successful transmitted using that profile. As a result, consideration must be made as to how noise and/or interference has affected the distribution of the probing samples in cluster 204. The greater the magnitude of the noise and/or interference in the spectrum over which the probing samples were obtained, the greater the distribution of the probing samples in the cluster will be, which in turn will cause the cluster to become wider and/or longer. Thus, the wider and/or longer the plot of a cluster is determined to be, the lower the spread value for the cluster will be as determined in step 254 needs to be in order to accommodate most of the probes assigned to that cluster.

One approach that may be used to calculate the spread value in step 254 is to calculate the spread of a specific cluster via its variance or standard deviation of each dimension in the probing samples assigned to a specific cluster. Another approach that may be used to calculate the spread value in step 254 is to calculate the variance or standard variation of the difference between the probes and their assigned clusters. The calculations for determining the spread value are done per minislot; as a result, in an embodiment, the results are a vector of spreads values, the vector being of a length corresponding to the number of minislots in the channel.

### Determine an Adjusted, or Marginalized MER, for Each Cluster

Having obtained a spread value for each cluster of probing samples, in step 256, for each cluster of probing samples, CCAP core 110 calculates a threshold MER for the cluster. The threshold MER is the result of adjusting the MER of the center points determined that cluster based on the spread value for the cluster. In effect, in performing step 256, CCAP core 110 subtracts a certain amount from the MER associated with the center points for each cluster based on the spread value, typically an amount twice or 3 times the standard variation. The calculated threshold MER value for a cluster is designed to be sufficient such that the cable modems represented in the cluster can use the profile using the threshold MER, since the channel has enough SNR to support most of those cable modems using that profile.

In an embodiment, an assumption is made that the MER measurements are spread in a normal distribution around the true MER center for that cluster. =By setting the threshold MER to be twice the standard deviation below the MER, approximately 95% of the time (as in the case of a normal distribution in which 95% of the samples falls inside a 2 time the standard deviation from the mean), the channel SNR will be higher than the threshold MER, so sending the information at the specific bit loading value (that matches that threshold MER via a lookup table) should result in the data arriving correctly to the other side.

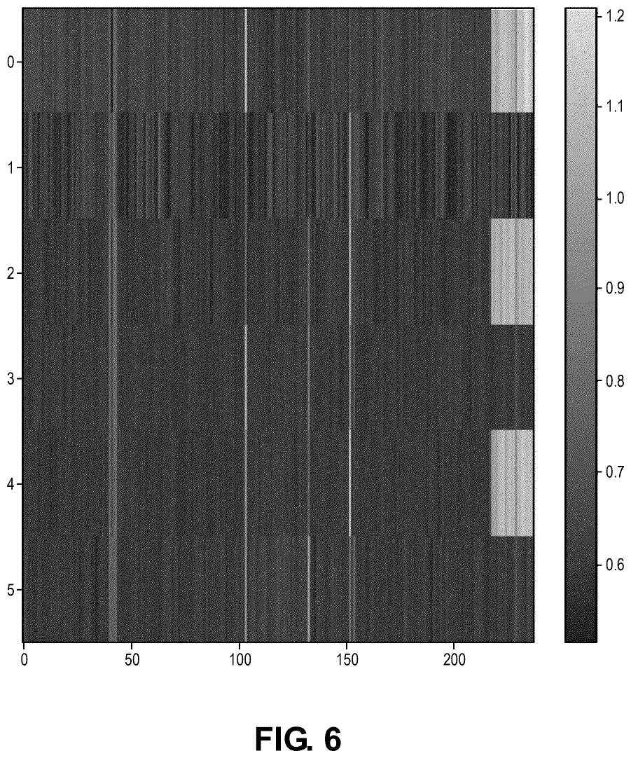

FIG. 6 is an illustration of determining how much variance there is between probing samples represented by each cluster in accordance with an embodiment of the invention. FIG. 6 depicts a calculation of the standard variation of probing samples around their assigned cluster center point per minislot. The vertical scale on the right of FIG. 6 shows an amount of variance for a given greyscale color. FIG. 6 shows portions of the spectrum (e.g., 237 minislots as indicated by the x-axis) in a lighter color where there is a high variance. When there is high variance present, a profile should employ a lower bit loading value to enable more cable modems using a lower signal-to-noise ratio (SNR) channel to be able to use that profile.

### Create a Profile for Each Cluster Using a Bit Loading Value or Modulation Order for That Cluster

In step 258, CCAP core 110 converts the threshold MER associated with each cluster into a bit loading value. In an embodiment, this may be done using a Bit Loading Lookup Table. The bit loading value (i.e., the number of bits per symbol/minislot that may be sent over the channel in a particular unit of time) is also known as the modulation order. The Bit Loading Lookup Table may be maintained at a location accessible to CCAP core 110. The Bit Loading Lookup Table is used to identify a specific bit loading value for a particular marginalized MER. When performing a lookup using the Bit Loading Lookup Table, the higher the marginalized MER, the higher the resulting bit loading value will be. The relationship between marginalized MER and bit loading value within Bit Loading Lookup Table is not linear but quantized in steps.

Having obtained a bit loading value, CCAP core 110 creates a profile for the channel being profiled using the determined bit loading value. If multiple clusters were identified, then the CMTS is able to pick from each profile created from one of the multiple clusters in real time for every CM depending on the probe it sends.

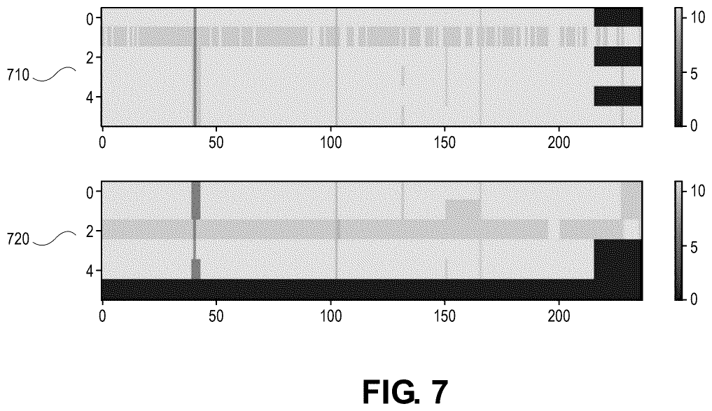

FIG. 7 is an illustration of a heatmap of different sets of optimized modulation profiles created in accordance with an embodiment of the invention. Heatmaps 710 and 720 depict different sets of optimized profiles. Since profiles may be generated using embodiments having lots of different bitload “bands” (i.e., a consecutive list of minislots having the same bitloading), and since such information must be conveyed downstream to the cable modems so that they are informed of which minislot has which bitload, a high number of different bands waste downstream bandwidth. Therefore, certain embodiments advantageously limit the number of bands to a specified number, e.g., 10, by merging similar bands such that the bitload impact is minimized. The end result of that compactization or band limiting is depicted in Heatmap 720, where the number of bands in each of the profiles is limited by 10, which is not the case in heatmap 710.

After CCAP core 110 creates a profile for the channel being profiled, CCAP core 110 may inform cable modems of the profile so that the cable modems may use that channel. Recall that profiles created using embodiments of the invention may be used in conjunction with an upstream channel or with a downstream channel

Advantageously, embodiments of the invention permit the assigned of profiles to cable modems not based on the physical deployment location of the cable modems or any characteristics of service provider customers associated with the cable modems, but rather upon the periodical channel conditions, includes ingress noise and other interference patterns, which may be experienced by those cable modems to which the profile is assigned. Further, embodiments of the invention are less computationally complex than prior approaches for modulation profile creation, as the complexity of embodiments is C(N) for N cable modem profiles, as opposed to the C(N³) computationally complexity common to prior art approaches for modulation profile creation. Another advantage possessed by embodiments over the prior art is that probing samples of channel conditions are obtained throughout the day. Doing so allows for discovering what channel bitloads may be employed and designing the modulation profiles accordingly based on this information. Thus, modulation profiles created using embodiments of the invention can specify optimal bitloads based on observed characteristics of the channel. In addition, if the channel conditions reoccur in a systematic fashion or pattern, then the modulation profile previously generated for the same or similar channels conditions may be used whenever such channel conditions are either determined or believed to be present.

### Extensions

The term “non-transitory computer-readable storage medium” as used herein refers to any tangible, physical medium that participates in persistently storing instructions or operational guidance which may be provided to a processor for execution. Additional details about the operation of non-transitory computer-readable storage mediums may be found within U.S. Pat. No. 11,212,590, issued Dec. 28, 2021, entitled “Multiple Core Software Forwarding,” the entire contents of which are hereby incorporated by reference for all purposes as if fully set forth herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A non-transitory computer-readable storage medium storing one or more sequences of instructions for dynamic creation of a Data Over Cable Service Interface Specification (DOCSIS) modulation profile, which when executed, cause:
probing conditions of a channel to obtain a plurality probing samples, wherein said plurality of probing samples are data that describe observed conditions of said channel;
clustering said plurality of probing samples to identify one or more clusters, wherein each of said one or more clusters is represented by one or more cluster center points,
determining, for each of said one or more clusters, a spread value, wherein said spread value is data that describes a shape and size of the cluster relative to the one or more cluster center points associated therewith;
identifying, for each of said one or more clusters, a threshold modulation error (MER) using the one or more cluster center points associated therewith and the spread value determined for that cluster, wherein the threshold MER identifies a particular adjustment to the modulation error of the one or more cluster center points; and
converting, for each of said one or more clusters, the threshold MER identified for that cluster into a bit loading value and creating a modulation profile using the bit loading value for that cluster.

2. The non-transitory computer-readable storage medium of claim 1, wherein said modulation profile is an upstream modulation profile.

3. The non-transitory computer-readable storage medium of claim 1, wherein said modulation profile is a downstream modulation profile.

4. The non-transitory computer-readable storage medium of claim 1, wherein said modulation profile is one or more of an orthogonal frequency-division multiplexing (OFDM) modulation profile and an orthogonal frequency-division multiple access (OFDMA) modulation profile.

5. The non-transitory computer-readable storage medium of claim 1, wherein execution of the one or more sequences of instructions further cause:
assigning said modulation profile to a particular cable modem based on observed periodical channel conditions, of said channel, experienced by said particular cable modem.

6. The non-transitory computer-readable storage medium of claim 1, wherein said spread value determined for said each of the one or more clusters is a vector of spread values, wherein the length of said vector corresponds to a number of minislots in said channel.

7. The non-transitory computer-readable storage medium of claim 1, wherein said creating the modulation profile comprises limiting how many bit loading bands are present in the modulation profile, wherein a bit load band is a consecutive sequence of minislots in said channel assigned the same bit loading value.

8. An apparatus for dynamic creation of a Data Over Cable Service Interface Specification (DOCSIS) modulation profile, comprising:
one or more processors; and
one or more non-transitory computer-readable storage mediums storing one or more sequences of instructions, which when executed, cause:
probing conditions of a channel to obtain a plurality probing samples, wherein said plurality of probing samples are data that describe observed conditions of said channel;
clustering said plurality of probing samples to identify one or more clusters, wherein each of said one or more clusters is represented by one or more cluster center points,
determining, for each of said one or more clusters, a spread value, wherein said spread value is data that describes a shape and size of the cluster relative to the one or more cluster center points associated therewith;
identifying, for each of said one or more clusters, a threshold modulation error (MER) using the one or more cluster center points associated therewith and the spread value determined for that cluster, wherein the threshold MER identifies a particular adjustment to the modulation error of the one or more cluster center points; and
converting, for each of said one or more clusters, the threshold MER identified for that cluster into a bit loading value and creating a modulation profile using the bit loading value for that cluster.

9. The apparatus of claim 8, wherein said modulation profile is an upstream modulation profile.

10. The apparatus of claim 8, wherein said modulation profile is a downstream modulation profile.

11. The apparatus of claim 8, wherein said modulation profile is one or more of an orthogonal frequency-division multiplexing (OFDM) modulation profile and an orthogonal frequency-division multiple access (OFDMA) modulation profile.

12. The apparatus of claim 8, wherein execution of the one or more sequences of instructions further cause:
assigning said modulation profile to a particular cable modem based on observed periodical channel conditions, of said channel, experienced by said particular cable modem.

13. The apparatus of claim 8, wherein said spread value determined for said each of the one or more clusters is a vector of spread values, wherein the length of said vector corresponds to a number of minislots in said channel.

14. The apparatus of claim 8, wherein said creating the modulation profile comprises limiting how many bit loading bands are present in the modulation profile, wherein a bit load band is a consecutive sequence of minislots in said channel assigned the same bit loading value.

15. A method for dynamically creating a Data Over Cable Service Interface Specification (DOCSIS) modulation profile, comprising:
probing conditions of a channel to obtain a plurality probing samples, wherein said plurality of probing samples are data that describe observed conditions of said channel;
clustering said plurality of probing samples to identify one or more clusters, wherein each of said one or more clusters is represented by one or more cluster center points,
determining, for each of said one or more clusters, a spread value, wherein said spread value is data that describes a shape and size of the cluster relative to the one or more cluster center points associated therewith;
identifying, for each of said one or more clusters, a threshold modulation error (MER) using the one or more cluster center points associated therewith and the spread value determined for that cluster, wherein the threshold MER identifies a particular adjustment to the modulation error of the one or more cluster center points; and
converting, for each of said one or more clusters, the threshold MER identified for that cluster into a bit loading value and creating a modulation profile using the bit loading value for that cluster.

16. The method of claim 15, wherein said modulation profile is an upstream modulation profile.

17. The method of claim 15, wherein said modulation profile is a downstream modulation profile.

18. The method of claim 15, wherein said modulation profile is one or more of an orthogonal frequency-division multiplexing (OFDM) modulation profile and an orthogonal frequency-division multiple access (OFDMA) modulation profile.

19. The method of claim 15, wherein execution of the one or more sequences of instructions further cause:
assigning said modulation profile to a particular cable modem based on observed periodical channel conditions, of said channel, experienced by said particular cable modem.

20. The method of claim 15, wherein said spread value determined for said each of the one or more clusters is a vector of spread values, wherein the length of said vector corresponds to a number of minislots in said channel.

21. The method of claim 15, wherein said creating the modulation profile comprises limiting how many bit loading bands are present in the modulation profile, wherein a bit load band is a consecutive sequence of minislots in said channel assigned the same bit loading value.
